(19) United States
(12) Patent Application Publication
(10) Pub. No.: US 2026/0243484 A1
(43) Pub. Date: Aug. 20, 2026

(54) Heat Pump, HVAC System and Compressor Device

(71) Applicant: Viessmann Holding International GmbH, Allendorf (Eder) (DE)

(72) Inventors: Artjom GRUBER, Schauenburg (DE); Gennadi STAROBINSKI, Kassel (DE); Peter SCHNEIDER, Marburg (DE)

(21) Appl. No.: 19/161,451

(22) PCT Filed: Apr. 22, 2024
(86) PCT No.: PCT/EP2024/060934

§ 371 Date: Sep. 2, 2025

(30) Foreign Application Priority Data
Apr. 28, 2023 (DE) 10 2023 111 051.9

(51) Int. Cl. F25B 49/02; H02P 29/64

(52) U.S. Cl. CPC F25B 49/022; H02P 29/64; F25B 2600/021; F25B 2700/151; F25B 2700/21154

(57) ABSTRACT

A heat pump, for use in an HVAC system, that has a compressor device including an electric motor for providing a mechanical movement for compressing a working medium, an inverter which supplies the electric motor with alternating current, a rectifier which supplies the inverter with direct current, and a monitoring device for monitoring an operating state of the electric motor. The monitoring device includes at least one measuring means for detecting an operating variable of the compressor device and an evaluation means for evaluating the detected operating variable, wherein the electric motor and the inverter are integrated jointly in a DC compressor unit that is coupled via a direct current interface to an electronics unit of the compressor device which is separated from said DC compressor unit and in which in turn the rectifier and the monitoring device are integrated jointly.

### TECHNICAL FIELD

The present invention relates to a heat pump, in particular for use in an HVAC system, an HVAC system with a heat pump, a compressor device for use in a heat pump and a method for monitoring a compressor device.

### BACKGROUND OF THE INVENTION

From the prior art, systems for heating, ventilation and air conditioning, so-called HVAC systems (German: HVAC systems) are known, with which, inter alia, a targeted and also as efficient as possible control of temperature, air humidity or air flow within a building or partial regions thereof is to be implemented.

Recently, for this purpose, heat pumps have increasingly been used, especially in private households, as a component of such HVAC systems, optionally as part of a heating system of the HVAC system for increasing room temperatures, but also as part of an air conditioning system of the HVAC system for lowering room temperatures.

Such heat pumps are thermodynamic devices which, via a connection to a heat source system, make various ambient energy sources, for example in the form of aerothermia, geothermia or hydrothermia, usable for heating and/or for air conditioning. For this purpose, the heat pump usually comprises a closed thermodynamic working circuit for a working medium, in which said working medium is compressed and expanded as well as heated and cooled according to the generally known principles, in such a way that heat energy can be transferred to the working medium at at least one point in the working circuit and heat energy can be extracted from the working medium at at least one further point in the working circuit, in order thus to implement a heat flow from or into a target system, for example a room of the building.

In the cases in which heat energy is to be extracted from the target system, for example in the region of air conditioning, the heat pump is often also referred to as a cold pump. In the following, however, heat pump is to be understood as a generic term which also comprises the embodiment as a cold pump.

An essential element in the working circuit of the heat pump is in this case the usually electrically operated compressor, via which the working medium is compressed in order to increase the pressure thereof. A failure of the compressor in this case nevertheless leads to the failure of the complete heat pump, which can be particularly critical precisely when used in an HVAC system. An example of this is a failure, caused as a result of component damage, of a heat pump designed as part of a heating system in cold winter months, as a result of which the building to be heated would cool down and thus become uninhabitable. Depending on the type of damage, a repair or an exchange can take several days in this case and is therefore to be avoided under all circumstances.

Precisely when using heat pumps as part of such HVAC systems, it is thus necessary to ensure failsafe operation over a long operating time of the heat pump, several years, if not even decades, in which, in particular, damage to individual components is ruled out as far as possible.

One of the most critical components of the heat pump is in this case the electrically operated compressor, which generally comprises an electric motor which provides the mechanical movement required for compressing the working medium. Said electric motor is operated in different power ranges depending on the naturally varying power requirements placed on the heat pump and in this case experiences different thermal, electrical and mechanical loads.

With regard to the safety standards regulated in DIN EN 60335-1, the operating state of the electric motor, as an electrical appliance for domestic use, should be monitored in order thus to detect critical operating states and under certain circumstances to take countermeasures, for example by means of a shutdown, which prevent unsafe operation and/or damage to the electric motor of the compressor. An example of such damage is a thermal overload of the rotor-side and/or stator-side windings of the electric motor, as a result of which, for example, the insulating layer applied to a conductor of a winding can be damaged, which can lead to a short circuit and under certain circumstances permanent damage to the electric motor.

Damage to the compressor, which naturally no longer sufficiently compresses the working medium in this case, can in this case have an effect on the other components of the heat pump which operate with the working medium and which under certain circumstances likewise experience damage.

### SUMMARY

It is therefore an object of the present invention to provide a possibility for compressing a working medium in a heat pump with an electrically operated compressor, which permits accurate and reliable monitoring for implementing safe operation, that is to say for avoiding critical operating states, with which in particular high safety standards can be complied with and damage to components of the heat pump can be reliably avoided.

In order to achieve this object, a heat pump according to claim 1, an HVAC system according to claim 12, a compressor device according to claim 13 and a method for monitoring a compressor device according to claim 14 are provided.

The respective dependent claims relate here to preferred embodiments which can be provided in each case by themselves or in combination.

According to a first aspect of the invention, a heat pump is provided, in particular for use in an HVAC system, which heat pump comprises, as part of a working circuit of the heat pump, at least one compressor device for compressing a working medium of the working circuit, wherein the compressor device in turn comprises an electric motor for providing a mechanical movement for compressing the working medium, an inverter which supplies the electric motor with alternating current, a rectifier which supplies the inverter with direct current, wherein the rectifier can be connected to an alternating current source for supplying energy to the compressor device, and a monitoring device for monitoring an operating state of the electric motor, which monitoring device comprises at least one measuring means for detecting an operating variable of the compressor device and an evaluation means for evaluating the detected operating variable, wherein the electric motor and the inverter, which supplies said electric motor with alternating current, are integrated jointly in a DC compressor unit of the compressor device, which DC compressor unit is coupled via a direct current interface to an electronics unit of the compressor device which is separated from said DC compressor unit and in which in turn the rectifier and the monitoring device are integrated jointly.

The design of the compressor device provided by the invention inherently has particularly good electromagnetic compatibility since the components operating with alternating current, namely the inverter and the electric motor, are separated from the remaining electrical components and are integrated jointly in a separate component, namely the DC compressor unit.

Electromagnetic compatibility is intended to be understood here as a measure of the ability of a technical component not to disturb other components by unwanted electrical or electromagnetic effects or to be disturbed by itself by other components. The electromagnetic compatibility can be formulated here both at the component level of an appliance and at the appliance level itself.

In the case of the compressor device according to the invention, above all the components operating with alternating current are main sources of electromagnetic fields which can influence other electrical or electronic components and in the case of these under certain circumstances can lead to functional disturbances and faulty behavior.

By means of the design according to the invention, in which inverter and electric motor and rectifier and monitoring device are each arranged “close” to one another, particularly good electromagnetic compatibility is thus achieved, in which above all the monitoring device which is embodied as part of the separate electronics unit is protected against negative influencing by the inverter and/or by the electric motor.

Thus, the inventors have found that the design according to the invention leads to substantially better electromagnetic compatibility since, as a result of the joint integration in the DC compressor unit, the spatial distance between the inverter and the electric motor is very small in contrast to the “classic” design with separate inverter and electric motor which is known from the prior art. As a result, the electrical connection between inverter and electric motor which is very critical with regard to the electromagnetic compatibility can be embodied comparatively shortly and in turn emits fewer electromagnetic disturbances which would have to be suppressed by sometimes complex design measures.

By means of arrangement in the separate electronics unit, the monitoring device is additionally shielded from the disturbance source described above.

In this way, not only the electromagnetic compatibility of the entire compressor device is improved, but also of the components thereof, with the result that, in particular, disturbances of the safety-relevant monitoring device are reduced.

This permits not only reliable operation of the compressor device, but also reliable monitoring with regard to critical operating states of the compressor device, which in turn increases the operational safety (for example by minimizing the risk of an electrical shock) and reduces the risk of damage to the compressor device. Such damage in this case under certain circumstances leads not only to a loss of function, but also to damage to other components of the heat pump.

Said critical operating states include, inter alia, overheating of windings of the electric motor, as a result of which, for example, the insulating layer applied to the conductor of a winding can be damaged, which leads to a short circuit and therefore to a permanent loss of function of the electric motor or even a state of the entire electrical system which is unsafe from a normative point of view, for example as a result of the risk of an electrical shock. Likewise, the electric motor can also be inhibited or even blocked, with the result that the mechanical movement for compressing does not take place as desired or under certain circumstances does not take place at all.

The separate arrangement of the two units (electronics unit and DC compressor unit) is intended to be understood here to mean that these are separate units or components as parts of which or in which the respective components (inverter, electric motor, rectifier etc.) are embodied or accommodated. The two units can (apart from the electrical connection via the DC interface) in this case (not necessarily) be arranged spaced apart from one another. In this case, an air gap or an intermediate layer can be present between the units.

The evaluation means of the monitoring device is preferably electronic and in particular processor-based and itself comprises means for signal transmission (transmission and reception). The evaluation means can be, for example, a control device of the compressor device or a part of such a control device. Alternatively, the evaluation means can also be coupled to a control device of the compressor device, or directly to a control device of the heat pump.

In a preferred embodiment, the DC compressor unit and the electronics unit each comprise a housing which can be spaced apart from one another, wherein at least a part of the electric motor, in particular the stator-side and/or rotor-side windings thereof which are supplied with current, and the inverter are arranged within the housing of the DC compressor unit and the rectifier and the monitoring device are arranged within the housing of the electronics unit.

Preferably, all the electrical components of the electric motor are arranged within the housing of the DC compressor unit.

The housings can each be produced, and not in a limiting manner, from plastic or from a metallic material.

In a preferred embodiment, at least the housing of the DC compressor unit comprises an electromagnetic shielding means, preferably in the form of metallic components of the housing or a metal foil or a metal mesh.

By means of the shielding means, the part of the electric motor and the inverter in the housing of the DC compressor unit are additionally electromagnetically shielded from the other electrical components of the compressor device.

In a preferred embodiment, however, an electromagnetic shielding means can also be arranged between the DC compressor unit and the electronics unit, for example between the respective housings of the said units.

In a preferred embodiment, the evaluation means is configured to determine at least one operating characteristic value describing the operating state of the electric motor as a function of the detected operating variable.

The operating characteristic values offer a particularly easily implementable possibility of identifying critical operating states, for example by detecting an exceeding of a limit value.

For example, one, two, three or more operating characteristic values can be determined, which can be, inter alia, values of electrical or mechanical variables of the electric motor.

In a preferred embodiment, the at least one measuring means is configured to detect a current strength and/or a voltage at the direct current interface.

Values of the said variables are in this case preferably detected at regular time intervals, as a result of which time profiles of the said operating variables are detected. In the following, the detected current strength and/or the detected voltage can denote both an individual value and a time profile.

In a preferred embodiment, the at least one measuring means is configured to detect a current strength at the direct current interface and the monitoring device comprises a further measuring means which is configured to detect a voltage at the direct current interface, wherein the evaluation means is likewise configured to evaluate the voltage detected by the further measuring means.

By detecting a plurality of operating variables, the operating state of the compressor device can be monitored even better.

In a preferred embodiment, the evaluation means of the monitoring device is configured to determine, based on the detected current strength and/or the detected voltage at the direct current interface, at least one effective value of a current flowing through a winding of the electric motor as an operating characteristic value of the electric motor, in particular an effective value of the voltage, the current strength or the electrical power of the current flowing through the winding of the electric motor, wherein each of the variables can preferably be handled as a separate operating characteristic value.

The description of the alternating current flowing in the winding by way of the determined effective values is kept simple and nevertheless representative in order to describe the complex, time-variant processes in the winding and to implement monitoring on the basis thereof.

In a preferred embodiment, the evaluation means of the monitoring device is configured to determine, based on the at least one determined effective value of the current flowing through the winding of the electric motor, a temperature of the winding of the electric motor as an operating characteristic value of the electric motor.

In this way, temperature monitoring is implemented without having to introduce a temperature sensor into the compressor device in order thus to detect, in particular, an operating state which is critical for the insulating layer of the windings.

The determination of the temperature is in this case carried out by means of a predetermined or a self-learning algorithm which receives the said effective values and/or the detected current strength and/or the detected voltage as input variables. Preferably, the algorithm includes design parameters and/or electrical parameters of the electric motor and/or of the inverter. Alternatively, the algorithm can also receive spectra of the respective operating characteristic values determined from time profiles of the detected operating characteristic values as input variables. Non-exhaustive examples of such spectra are transformations of the time profiles into a frequency range, for example using an FFT or the like.

Preferably, the determination of the temperature is in this case carried out by means of the algorithm on the basis of second or all three effective values of voltage, current strength or electrical power of the current flowing through the winding.

Alternatively, the evaluation means of the monitoring device is configured to determine, based on the detected current strength and/or the detected voltage at the direct current interface, a temperature of a winding of the electric motor as an operating characteristic value of the electric motor.

In this case, the algorithm worked directly with the detected current strength and/or the detected voltage (or the time profiles thereof), without previously determining effective values.

In a preferred embodiment, the evaluation means is configured to determine, based on the detected current strength and/or the detected voltage at the direct current interface, a rotational speed of the electric motor as an operating characteristic value of the electric motor.

In this way, it is possible to infer an inhibited or even blocked electric motor which compresses the working medium inadequately or no longer at all.

In a preferred embodiment, the compressor device furthermore comprises a switch unit, which is coupled to the monitoring device, for interrupting a supply of energy to the electric motor by the alternating current source, wherein the compressor device, in particular the evaluation means, is configured to interrupt, via the switch unit, the supply of energy to the electric motor based on at least one operating characteristic value of the electric motor determined by the evaluation means, in particular if said operating characteristic value lies outside a predetermined setpoint range.

In this way, a critical operating state can be prevented and/or ended by immediate cutting off of the supply of energy, with the result that, as far as possible, no unsafe operating state and/or damage to the compressor device occurs.

The said operating characteristic values can be (not in a limiting manner) the above-described effective values of the current, the temperature of the winding or the rotational speed of the electric motor, or else spectra in a frequency range which are derived from time profiles of these variables.

Preferably, the evaluation means is configured to interrupt, for each determined operating characteristic value, the supply of energy via the switch unit, in particular if one of the determined operating characteristic values lies outside a respective predetermined setpoint range.

In this way, the monitoring is extended to a plurality of operating characteristic values.

Preferably, the switch unit is connected between the alternating current source and the rectifier, with the result that the current flow between alternating current source and rectifier can be interrupted, as a result of which the electrical safety of the heat pump is ensured and, inter alia, the complete electronics of the compressor device are also protected from damage.

Alternatively, however, the switch unit can also be arranged downstream of the rectifier, in particular between rectifier and inverter, in relation to the electrical energy flow.

Preferably, an interruption is carried out if the determined operating characteristic value lies outside an associated setpoint range. In particular, this can be implemented by means of a limit value monitoring with time-continuous or repetitive detection of the operating variable and determination of the operating value or the operating value by the monitoring device, in which monitoring is carried out whether the determined operating characteristic value exceeds an upper and/or lower limit of its associated setpoint range.

The setpoint ranges can in this case be predetermined externally by an operator, for example on the basis of test stand measurements, be predetermined by means of a simulation program or be predetermined by means of a self-learning algorithm in the course of a learning phase. Preferably, the setpoint ranges are adaptable, in particular the evaluation means is configured to adapt the setpoint ranges as a function of the operating variables detected by the measuring units of the monitoring device.

Preferably, the compressor device furthermore comprises at least one sensor, which is coupled to the monitoring device, for detecting a state variable of the working medium in the working circuit, in particular a pressure sensor, such that the state variable is a pressure of the working medium, wherein the evaluation means is configured to interrupt, via the switch unit, the supply of energy to the electric motor based on a value of the state variable detected by the at least one sensor.

In this way, the monitoring is additionally supplemented by thermodynamic operating variables of the compressor device, as a result of which this can be implemented even more reliably and more accurately.

Preferably, an interruption is carried out if the detected value of the state variable lies outside a predetermined second setpoint range. In particular, this can be implemented by means of a limit value monitoring with time-continuous or repetitive detection by the monitoring device, in which monitoring is carried out whether the detected value of the state variable exceeds a limit of the second setpoint range.

Preferably, the compressor device comprises such a sensor both at a compressor inlet for the working medium and at a compressor outlet, wherein the evaluation means is configured to interrupt, via the switch unit, the supply of energy to the electric motor based on the two values of the state variable, which is detected by the two sensors, of the working medium at the compressor inlet and at the compressor outlet.

In this way, a degree of compression of the working medium can be determined, via which a faulty behavior during compression can be detected. Thus, a suddenly falling degree of compression with unchanged setting of the heat pump usually indicates an inhibition or blockage of the electric motor.

In a preferred embodiment, the heat pump is designed as part of a heating system of an HVAC system which is configured to heat a building.

Especially recently, heat pumps, as alternatives to oil-and gas-based systems, have been used as a heating system in HVAC systems. Here, safe and reliable operation has to be ensured, in particular during cold winter months, which is ensured by the heat pump according to the invention.

According to a second aspect of the invention, an HVAC system is provided which comprises a heat pump at least according to the first aspect or one of its preferred embodiments.

In this way, the above-described advantages of the heat pump according to the invention can be transferred to the complete HVAC system, as a result of which, inter alia, its reliable and energy-efficient operation can also be ensured.

The designation HVAC system here denotes any combination of one or more of the subsystems combined thereunder, that is to say a heating system, a ventilation system and an air conditioning system, such that an HVAC system in the sense of the invention does not have to comprise all of the above subsystems.

Thus, the heat pump can be used, for example, in a heating system and/or in an air conditioning system of the HVAC system.

According to a third aspect of the invention, a compressor device is provided which is suitable in particular for use in a heat pump, preferably in a heat pump according to the first aspect of the invention. The compressor device comprises an electric motor for providing a mechanical movement for compressing a working medium, an inverter which supplies the electric motor with alternating current, a rectifier which supplies the inverter with direct current, wherein the rectifier can be connected to an alternating current source for supplying energy to the compressor device, and a monitoring device for monitoring an operating state of the electric motor, which monitoring device comprises at least one measuring means for detecting an operating variable of the compressor device and an evaluation means for evaluating the detected operating variable. The electric motor and the inverter, which supplies said electric motor with alternating current, are integrated jointly in a DC compressor unit of the compressor device, which DC compressor unit is coupled via a direct current interface to an electronics unit of the compressor device which is separated from said DC compressor unit and in which in turn the rectifier and the monitoring device are integrated jointly.

In this way, any desired heat pump can be retrofitted with the compressor device according to the invention, in order thus to arrive at a heat pump according to the first aspect of the invention with all the advantages thereof.

However, the use of the compressor device is not restricted here to a heat pump of an HVAC system, but rather can also be used in other heat pumps, thus, for example, in a heat pump of a refrigerator/freezer, of a tumble dryer and of other domestic appliances.

According to a fourth aspect of the invention, a method for monitoring the compressor device at least according to the third aspect or one of its preferred embodiments is provided. The method comprises at least operating the compressor device by supplying the rectifier of the compressor device with alternating current by means of an alternating current source, detecting at least one operating variable of the compressor device by means of the at least one measuring means of the monitoring device and determining an operating characteristic value describing an operating state of the electric motor of the compressor device as a function of the detected operating variable by means of the evaluation means of the monitoring device, in particular in order thus to detect a dangerous state and to enable the safety-related interruption of the supply of energy to the compressor device.

In a preferred embodiment, the at least one measuring means is configured to detect a current strength and/or a voltage at the direct current interface of the compressor device, wherein detecting the operating variable of the compressor device further comprises detecting a current strength and/or a voltage at the direct current interface of the compressor device.

Preferably, determining the operating characteristic value describing the operating state of the electric motor of the compressor device further comprises determining an effective value of a current flowing through a winding of the electric motor, in particular an effective value of the voltage, the current strength or the electrical power, as a function of the detected current strength and/or the detected voltage at the direct current interface, and outputting the determined effective value as an operating characteristic value of the electric motor.

Alternatively, determining the operating characteristic value describing the operating state of the electric motor of the compressor device further comprises determining an effective value of a current flowing through a winding of the electric motor, in particular an effective value of the voltage, the current strength or the electrical power, as a function of the detected current strength and/or the detected voltage at the direct current interface, and determining a temperature of the winding of the electric motor as a function of the determined effective value of the current flowing through the winding of the electric motor, and outputting the determined temperature as an operating characteristic value of the electric motor.

Further alternatively, determining the operating characteristic value describing the operating state of the electric motor of the compressor device further comprises determining an effective value of a current flowing through a winding of the electric motor, in particular an effective value of the voltage, the current strength or the electrical power, as a function of the detected current strength and/or the detected voltage at the direct current interface, and determining a temperature of the winding of the electric motor as a function of the detected current strength and/or the detected voltage at the direct current interface, and outputting the determined temperature as an operating characteristic value of the electric motor.

Preferably, the method comprises switching off the compressor device, in particular by interrupting a supply of current to the electric motor, if at least one or more of the determined operating characteristic values lie outside a respective predetermined setpoint range. Preferably, the interruption is in this case carried out by interrupting an electrical connection between the rectifier and the alternating current source.

Further aspects and the advantages thereof and also more specific exemplary embodiments of the abovementioned aspects and embodiments are described below with the aid of the drawings shown in the appended figures.

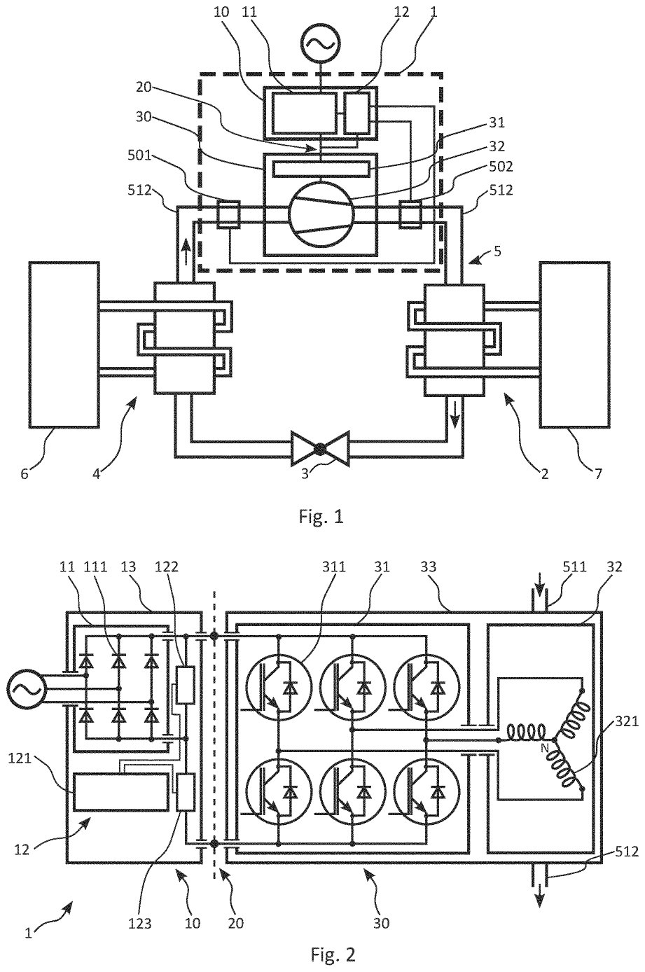

FIG. 1 schematically shows an exemplary embodiment of the heat pump according to the invention.

FIG. 2 schematically shows a first exemplary embodiment of the compressor device according to the invention.

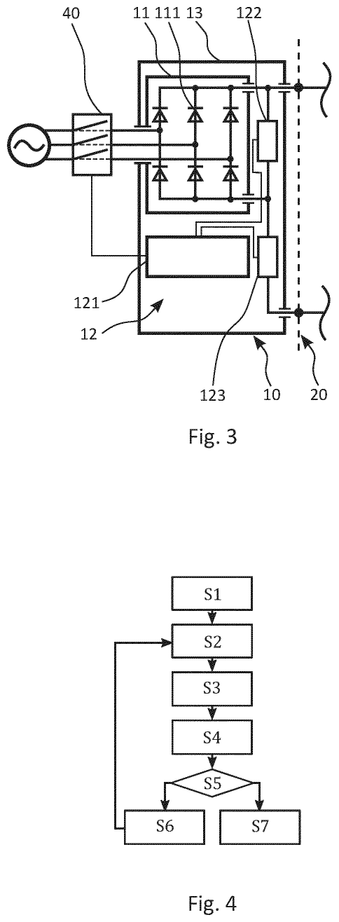

FIG. 3 schematically shows a second exemplary embodiment of the compressor device according to the invention.

FIG. 4 shows a flow diagram of a first exemplary embodiment of the method according to the invention for monitoring a compressor device.

It is emphasized that the present invention is in no way limited to the exemplary embodiments described below and the exemplary features thereof. The invention furthermore comprises modifications of the exemplary embodiments mentioned, in particular those which emerge from modifications and/or combinations of individual or a plurality of features of the exemplary embodiments described within the scope of protection of the independent claims.

### DETAILED DESCRIPTION OF THE FIGURES

FIG. 1 schematically shows an exemplary embodiment of the heat pump according to the invention.

The heat pump comprises, arranged in a working circuit for a working medium, a compressor device 1, a condenser 2, an expansion valve 3 and an evaporator 4.

The illustrated heat pump 1 is configured for heating operation in such a way that heat energy is transferred by the thermodynamic circuit from the heat source system 6 to the heat receiver 7, for example to a hot water circuit of a heater or to a hot water heater for service water.

For this purpose, the condenser 2 is thermally coupled to a heat receiver 7, in order to supply said heat receiver with heat energy extracted from the working medium in the condenser 2. The evaporator 3 is thermally coupled to a heat source system 6, in order to transfer heat energy from said heat source system to the working medium.

The compressor device 1 serves for compressing the heated and thus usually gaseous working medium and comprises for this purpose an electric motor 32 for providing a mechanical movement for compressing the working medium.

The electric motor 32 is supplied with alternating current. For this purpose, an inverter 31 is connected upstream of the electric motor, which inverter is in turn supplied with direct current via a rectifier 11 connected upstream thereof. The rectifier 11 is in turn supplied with alternating current via an alternating current source (~).

For monitoring an operating state of the compressor device 1, in particular of the electric motor 32 thereof, said compressor device comprises a monitoring device 12 which comprises at least one measuring means for detecting an operating variable of the compressor device 1 and an evaluation means for evaluating the detected operating variable.

The electric motor 32 and the inverter 31, which supplies said electric motor with alternating current, are integrated jointly in a DC compressor unit 30 (DC for German: direct current) of the compressor device 1.

The rectifier 11 and the monitoring device 12 are integrated jointly in a separate electronics unit 10, wherein the electronics unit 10 and the DC compressor unit 30 are coupled to one another via a direct current interface 20.

In this case, the monitoring device 12 preferably taps the operating variable or operating variables to be detected for monitoring the compressor device 1 via measuring means at the direct current interface 20.

The design of the compressor device 1 provided by the invention inherently has particularly good electromagnetic compatibility since the components operating with alternating current, namely the inverter 31 and the electric motor 32, are separated from the remaining electrical components and are integrated jointly in a separate component, namely the DC compressor unit 30.

Thus, above all the components operating with alternating current are main sources of electromagnetic fields which can influence other electrical or electronic components and in the case of these under certain circumstances can lead to functional disturbances and faulty behavior.

The compressor device furthermore comprises pressure sensors 501, 502 which are each arranged on the side of the compressor inlet 511 and of the compressor outlet 512 for the working medium and are each configured to detect a pressure of the working medium.

The pressure sensors 501, 502 are coupled to the monitoring device 12 and are available to the latter, in particular to the evaluation means, as additional variables for the purpose of monitoring the electric motor 32.

Thus, via the detected pressure values at the compressor inlet 511 and at the compressor outlet 512, it is possible to infer, for example, an inadequate or even no compression taking place.

The heat pump 1 described above is not to be understood as being restricted to heating operation, but rather can also be used as a cold pump.

FIG. 2 schematically shows a first exemplary embodiment of the compressor device 1 according to the invention.

The compressor device 1 serves for compressing a working medium which enters the compressor device 1 through compressor inlet 511 and exits the compressor outlet 512 again in a compressed state.

For compressing the working medium, the compressor device 1 comprises an electric motor 32 embodied as a three-phase motor, the rotor-side and/or stator-side windings 321 of which are supplied in the present case with three-phase alternating current (three-phase current) in order to provide a mechanical movement for compressing the working medium. The electric motor 32 is not intended to be restricted here to a three-phase motor, but rather electric motors can also be used which are operated with any other type of alternating current.

The electric motor 32 is supplied with alternating current, as described. For this purpose, an inverter 31 is connected upstream of the electric motor 32, which inverter is in turn supplied with direct current via a rectifier 11 connected upstream thereof. The rectifier 11 is in turn supplied with alternating current via an alternating current source (~).

Rectifier 11 and inverter 31 can be configured in accordance with the embodiments customary in the prior art. Thus, in the present case, the rectifier 11 comprises a plurality of diodes 111 connected in accordance with the circuit diagram shown in FIG. 2, and the inverter 31 comprises a plurality of IGBTs connected in accordance with the circuit diagram shown in FIG. 2.

For monitoring an operating state of the compressor device 1, in particular of the electric motor 32 thereof, said compressor device comprises a monitoring device 12 which, in the present exemplary embodiment, comprises two measuring means, namely a voltage meter 122 and a current strength meter 123, and an evaluation means 121 coupled thereto is configured to evaluate the detected current strength and/or the detected voltage.

The electric motor 32 and the inverter 31, which supplies said electric motor with alternating current, are integrated jointly in a DC compressor unit 30 (DC for German: direct current) of the compressor device 1.

The rectifier 11 and the monitoring device 12 are integrated jointly in a separate electronics unit 10, wherein the electronics unit 10 and the DC compressor unit are coupled to one another via a direct current interface 20.

FIG. 2 shows here the advantageous design, already described in the context of FIG. 1, of the compressor device 1 with intrinsically particularly good electromagnetic compatibility.

Preferably, the inverter 31 and the electric motor 32 or at least the winding(s) 321 thereof are accommodated jointly in a housing 33 of the DC compressor unit 30. For further improvement of the electromagnetic compatibility within the compressor device 1, the housing 33 can comprise here an electromagnetic shielding means (not illustrated here). The shielding means can be (not in a limiting manner) a metal foil or a metal mesh or else can be implemented by a partial or complete provision of the housing 333 as a metallic housing.

Preferably, the rectifier 11 and the monitoring device 12 are accommodated jointly in a housing 13 of the electronics unit 10. For further improvement of the electromagnetic compatibility within the compressor device 1, the housing 13 can comprise here an electromagnetic shielding means (not illustrated here). The shielding means can be (not in a limiting manner) a metal foil or a metal mesh.

The two housings 13, 33 can be arranged spaced apart from one another. This can be understood such that the housings 13, 33 have no direct contact, but rather at least an air gap or an intermediate layer is present between them. The intermediate layer can optionally be an electrically insulating material. Alternatively, however, the housings 13, 33 can also bear against one another.

The said intermediate layer between the two housings 13, 33 can preferably be an electromagnetic shielding means, as a result of which the electromagnetic compatibility within the compressor device 1 is further improved.

The evaluation means 121 is preferably electronic and in particular processor-based and itself comprises means for signal transmission (transmission and reception). The evaluation means 1 can be, for example, a control device of the compressor device 1 or a part of such a control device. Alternatively, the evaluation means 121 can be coupled to a control device of the compressor device 1, or directly to a control device of a heat pump in which the compressor device 1 shown is used.

The evaluation means 121 is configured to receive and evaluate the values detected by the voltage meter 122 and by the current strength meter 123, in the course of which the evaluation means 121 is configured to determine at least one operating characteristic value describing the operating state of the electric motor 32 as a function of the detected values. In this case, one or more operating characteristic values can be determined.

The determined operating characteristic value or values can in this case be used for control by a control device of the compressor device 1, can be displayed to an operator via a display (not illustrated here), or can be transmitted to an external monitoring system (not illustrated here).

Preferably, an operating characteristic value to be determined by the evaluation means 121 is one or more effective values, in particular an effective value of the voltage, the current strength and/or the electrical power, of a current flowing through the winding 321 of the electric motor 32, which are determined on the basis of the detected values of the voltage meter 122 and/or of the current strength meter 123.

On the basis of the determined effective value or values as operating characteristic values of the electric motor 32, the operating state of the compressor device can be monitored to the effect that a critical operating state, for example in the form of overheating of the winding 321 of the electric motor 32, can be detected in a timely manner, as a result of which damage or unsafe operation can be prevented. The said monitoring is in this case particularly reliable on account of the design according to the invention with improved electromagnetic compatibility.

Preferably, alternatively or additionally, a temperature of the winding 321 can be determined as an operating characteristic value from the detected values of the voltage meter 122 and/or of the current strength meter 123 or from effective values of the current determined as described above.

The design shown in FIG. 2 is in this case in no way restricted to continuous use of three-phase current (three-phase alternating current). Thus, any other alternating current, for example with one or two phases, can also be used both as an output of the alternating current source and/or as an input for the electric motor 32, wherein the number of phases of the alternating current source can also deviate from that of the electric motor 32. The changes to the rectifier 11 and/or to the inverter 31 and/or to the electric motor 32 which are necessary for conversion to another type of alternating current are known to the person skilled in the art.

The compressor device 1 in the embodiment described above for FIG. 2 can also be used in the heat pump shown in FIG. 1.

FIG. 3 schematically shows a detail of a second exemplary embodiment of the compressor device 1 according to the invention.

The second exemplary embodiment corresponds in large parts to the first exemplary embodiment from FIG. 2 and differs from the latter by the switch unit 40 which is arranged between the alternating current source and the electronics unit 10 and which is coupled to the evaluation means 121 of the monitoring device 12.

The switch unit 40 is controllable and at least configured to interrupt a current flow between alternating current source and rectifier 11 and thus interrupt the supply of energy to the electric motor 32.

The evaluation means 121 is in this case configured to actuate the switch unit 40 and to interrupt, via the switch unit 40, an electrical connection between the rectifier 11 and the alternating current source.

The interruption by actuating the switch unit 40 is in this case preferably carried out on the basis of an operating characteristic value determined by the evaluation means 121, in particular a determined effective value of the current flowing through the winding 321 or a temperature of the winding 321. If at least one of the determined operating characteristic values lies outside a predetermined setpoint range, this is evaluated as a critical operating state and the evaluation means 121 transmits a signal to the switch unit 40, as a result of which the switch unit 40 interrupts the current flow, in order thus to avoid an unsafe operating state and to protect the compressor device 1 from damage.

Optionally, the switch unit 40 can also be embodied as part of the electronics unit 10 and in particular can also be integrated jointly with the rectifier 11 and the monitoring device 12 in the same housing 13.

Alternatively to the arrangement illustrated in FIG. 3, however, the switch unit 40 can also be arranged between the rectifier 11 and the inverter 31 in accordance with a third exemplary embodiment of the compressor device 1, in relation to FIG. 2.

The compressor device 1 in the embodiment described above for FIG. 3 can likewise be used in the heat pump shown in FIG. 1.

FIG. 4 shows a flow diagram of a first exemplary embodiment of the method according to the invention for monitoring a compressor device.

In this case, the monitored compressor device comprises at least one electric motor for providing a mechanical movement for compressing a working medium, an inverter which supplies the electric motor with alternating current, a rectifier which supplies the inverter with direct current, wherein the rectifier can be connected to an alternating current source for supplying energy to the compressor device, and a monitoring device which comprises at least one measuring means for detecting an operating variable of the compressor device and an evaluation means for evaluating the detected operating variable. The electric motor and the inverter, which supplies said electric motor with alternating current, are integrated jointly in a DC compressor unit of the compressor device, which DC compressor unit is coupled via a direct current interface to an electronics unit of the compressor device which is separated from said DC compressor unit and in which in turn the rectifier and the monitoring device are integrated jointly.

In step S1, the compressor device is operated by supplying the rectifier of the compressor device with alternating current by means of an alternating current source. The alternating current of the alternating current source can be, for example, a two-phase or a three-phase alternating current.

In step S2, a first operating variable of the compressor device is detected by means of the at least one measuring means of the monitoring device, wherein the at least one measuring means is configured to detect a current strength at the direct current interface, for example in the form of an ammeter, and therefore the first operating variable is a current strength.

In step S3, a second operating variable of the compressor device is detected by means of a further measuring means of the monitoring device, wherein the further measuring means is configured to detect an electrical voltage at the direct current interface, for example in the form of a voltmeter, and therefore the second operating variable is a voltage.

In step S4, an operating characteristic value describing the operating state of the electric motor of the compressor device is determined as a function of the detected current strength and the detected voltage from steps S2 and S3 by means of the evaluation means of the monitoring device, wherein the operating characteristic value is preferably an effective value of a current flowing through a winding of the electric motor, preferably an effective current strength, but optionally also effective values of the voltage or the electrical power of the current flowing through the winding.

Optionally, the determined operating characteristic value can be output to an operator of the compressor device, with the result that the latter can be informed about the current operating state.

In step S5, the determined effective current strength (as determined operating characteristic value) is evaluated by comparing the effective current strength with a predetermined first limit value which can be understood as a limit of a predetermined first setpoint range. Depending on whether the effective current strength, voltage or electrical power are selected as operating characteristic value for the method, the first limit value or the first setpoint range naturally differs and the first limit value can be an upper or a lower limit of the setpoint range. In the present case, for example, the first limit value is selected as upper limit of a setpoint range.

If the effective current strength lies below the predetermined first limit value for the current strength, there is no critical operating state of the electric motor and the method is repeated after a pause of predetermined duration in step S6 starting from step S2.

If, by contrast, the effective current strength lies above the predetermined first limit value, there is a critical operating state of the electric motor and the method proceeds to step S7.

In step S7, the compressor device is switched off, in particular by disconnecting the supply of current to the electric motor. Preferably, this is carried out by disconnecting the electrical connection between the rectifier and the external alternating current source.

In this way, safe operation is ensured and the compressor device can be protected, inter alia, from damage which could result from the critical operating state.

Exemplary embodiments of the present invention and the advantages thereof have been described in detail above with reference to the appended figures.

It is again emphasized that the present invention is in no way limited to the exemplary embodiments described above and the exemplary features thereof. The invention furthermore comprises modifications of the exemplary embodiments mentioned, in particular those which emerge from modifications and/or combinations of individual or a plurality of features of the exemplary embodiments described within the scope of protection of the independent claims.

### LIST OF REFERENCE SIGNS

1 Compressor device
2 Condenser
3 Expansion valve
4 Evaporator
5 Line system for working medium
6 Heat source system
7 Heat receiver
10 Electronics unit
11 Rectifier
12 Monitoring device
13 Housing of the electronics unit
20 Direct current interface
30 DC compressor unit
31 inverter
32 electric motor
33 Housing of the DC compressor unit
40 Switch unit
111 diode
121 Evaluation means
122 Voltage meter
123 Current strength meter
311 IGBT
321 winding of the electric motor
501 first pressure gauge
502 second pressure gauge
511 compressor inlet for working medium
512 compressor outlet for working medium

1. A heat pump for use in an HVAC system, which comprises, as part of a working circuit of the heat pump, at least one compressor device (1) for compressing a working medium of the working circuit,
wherein the compressor device (1) in turn comprises:
an electric motor (32) for providing a mechanical movement for compressing the working medium;
an inverter (31) which supplies the electric motor (32) with alternating current;
a rectifier (11) which supplies the inverter (31) with direct current, wherein the rectifier (11) can be connected to an alternating current source for supplying energy to the compressor device (1); and
a monitoring device (12) for monitoring an operating state of the electric motor (32), which monitoring device comprises at least one measuring means (122, 123) for detecting an operating variable of the compressor device (1) and an evaluation means (121) for evaluating the detected operating variable;
wherein the electric motor (32) and the inverter (31), which supplies said electric motor with alternating current, are integrated jointly in a DC compressor unit (30) of the compressor device (1), which DC compressor unit is coupled via a direct current interface (20) to an electronics unit (10) of the compressor device (1) which is separated from said DC compressor unit and in which in turn the rectifier (11) and the monitoring device (12) are integrated jointly.

2. The heat pump according to claim 1, wherein
the DC compressor unit (30) and the electronics unit (10) each comprise a housing (13, 33) which are preferably spaced apart from one another, wherein at least a part of the electric motor (32) and the inverter (31) are arranged within the housing (33) of the DC compressor unit (30) and the rectifier (11) and the monitoring device (12) are arranged within the housing (13) of the electronics unit (10).

3. The heat pump according to claim 2, wherein
at least the housing (33) of the DC compressor unit (30) comprises an electromagnetic shielding means, preferably in the form of metallic components of the housing (33) or in the form of a metal foil or a metal mesh.

4. The heat pump according to claim 1, wherein
the evaluation means (121) is configured to determine at least one operating characteristic value describing the operating state of the electric motor (32) as a function of the detected operating variable.

5. The heat pump according to claim 4, wherein
the at least one measuring means (122, 123) is configured to detect a current strength and/or a voltage at the direct current interface (20).

6. The heat pump according to claim 5, wherein
the at least one measuring means (123) is configured to detect a current strength at the direct current interface (20), and
the monitoring device (12) comprises a further measuring means (122) which is configured to detect a voltage at the direct current interface (20), wherein the evaluation means (121) is likewise configured to evaluate the voltage detected by the further measuring means (122).

7. The heat pump according to claim 5, wherein
the evaluation means (121) of the monitoring device (12) is configured to determine, based on the detected current strength and/or the detected voltage at the direct current interface (20), at least one effective value of a current flowing through a winding (321) of the electric motor (32) as an operating characteristic value of the electric motor (32), the at least one effective value being an effective value of the voltage, the current strength or the electrical power of the current flowing through the winding (321) of the electric motor (32).

8. The heat pump according to claim 7, wherein
the evaluation means (121) of the monitoring device (12) is configured to determine, based on the at least one determined effective value of the current flowing through the winding (321) of the electric motor (32), a temperature of the winding (321) of the electric motor (32) as an operating characteristic value of the electric motor (32).

9. The heat pump according to claim 5, wherein
the evaluation means (121) of the monitoring device (12) is configured to determine, based on the detected current strength and/or the detected voltage at the direct current interface (20), a temperature of a winding (321) of the electric motor (32) as an operating characteristic value of the electric motor (32).

10. The heat pump according to claim 5, wherein
the evaluation means (121) is configured to determine, based on the detected current strength and/or the detected voltage at the direct current interface (20), a rotational speed of the electric motor (32) as an operating characteristic value of the electric motor (32).

11. The heat pump according to claim 4, wherein
the compressor device (1) further comprises a switch unit (40), which is coupled to the monitoring device (12), for interrupting a supply of energy to the electric motor (32) and which is connected between the rectifier (11) and the alternating current source or between the rectifier (11) and the inverter (31), and
the evaluation means (121) is configured to interrupt, via the switch unit (40), the supply of energy to the electric motor (32) based on at least one operating characteristic value of the electric motor (32) determined by the evaluation means (121), if said operating characteristic value lies outside a predetermined setpoint range.

12. A HVAC system for use in a building, comprising
a heat pump according to claim 1.

13. A compressor device (1) for use in a heat pump according to one claim 1, comprising:
an electric motor (32) for providing a mechanical movement for compressing a working medium;
an inverter (31) which supplies the electric motor (32) with alternating current;
a rectifier (11) which supplies the inverter (31) with direct current, wherein the rectifier (11) can be connected to an alternating current source for supplying energy to the compressor device (1); and
a monitoring device (12) for monitoring an operating state of the electric motor (32), which monitoring device comprises at least one measuring means (122, 123) for detecting an operating variable of the compressor device (1) and an evaluation means (121) for evaluating the detected operating variable;
wherein the electric motor (32) and the inverter (31), which supplies said electric motor with alternating current, are integrated jointly in a DC compressor unit (30) of the compressor device (1), which DC compressor unit is coupled via a direct current interface

(20) to an electronics unit (10) of the compressor device (1) which is separated from said DC compressor unit and in which in turn the rectifier (11) and the monitoring device (12) are integrated jointly.

14. A method for monitoring a compressor device (1) at least according to claim 13, comprising the steps of:
operating the compressor device (1) by supplying the rectifier (11) of the compressor device (1) with alternating current by means of an alternating current source;
detecting at least one operating variable of the compressor device (1) by means of the at least one measuring means (122, 123) of the monitoring device (12); and
determining at least one operating characteristic value describing an operating state of the electric motor (32) of the compressor device (1) as a function of the detected operating variable by means of the evaluation means (121) of the monitoring device (12).

15. The method according to claim 14, wherein
the at least one measuring means (122, 123) is configured to detect a current strength and/or a voltage at the direct current interface (20) of the compressor device (1), wherein detecting the operating variable of the compressor device (1) further comprises:
detecting a current strength and/or a voltage at the direct current interface (20) of the compressor device (1); and
determining the at least one operating characteristic value describing the operating state of the electric motor (32) of the compressor device (1) in turn comprises:
determining an effective value of a current flowing through a winding (321) of the electric motor (32), the effective value being an effective value of the voltage, the current strength or the electrical power, as a function of the detected current strength and/or the detected voltage at the direct current interface (20), and
outputting the determined effective value as an operating characteristic value of the electric motor (32); and/or
determining the at least one operating characteristic value describing the operating state of the electric motor (32) of the compressor device (1) in turn comprises:
determining an effective value of a current flowing through a winding (321) of the electric motor (32), the effective value being an effective value of the voltage, the current strength or the electrical power, as a function of the detected current strength and/or the detected voltage at the direct current interface (20), and
determining a temperature of the winding (321) of the electric motor (32) as a function of the determined effective value of the current flowing through the winding

(321) of the electric motor (32);
or
determining a temperature of the winding (321) of the electric motor (32) as a function of the detected current strength and/or the detected voltage at the direct current interface (20);
and
outputting the determined temperature as an operating characteristic value of the electric motor (32).
